(19) United States
(12) Patent Application Publication
(10) Pub. No.: US 2004/0182757 A1
(43) Pub. Date: Sep. 23, 2004

(54) Screening module and a screening assembly including such module

(76) Inventors: John William Eeles, Eleebana (AU); Peter Martin Olsen, Toronto (AU)

Correspondence Address: GREENBERG TRAURIG LLP, 2450 COLORADO AVENUE, SUITE 400E, SANTA MONICA, CA, 90404, US

(21) Appl. No.: 10/789,891

(22) Filed: Feb. 26, 2004

Related U.S. Application Data
(62) Division of application No. 10/149,006, filed on Sep. 25, 2002, now Pat. No. 6,715,613.
Application No. 10/149,006 is a 371 of international application No. PCT/AU00/01500, filed on Dec. 6, 2000.

(30) Foreign Application Priority Data
Dec. 9, 1999 (AU) PQ 4558

(51) Int. Cl. B07B 1/49

(52) U.S. Cl. 209/403

(57) ABSTRACT

A screening assembly framework includes a plurality of support members, each of which supports at least one securing element by which a screening module is secured to the support member. A plurality of spacer members are arranged intermediate the support members for retaining the support members at a predetermined distance relative to one another, at least certain of the support members and at least certain of the spacer members being demountably connected to one another to form a demountable underlying structure for an array of screening modules of the screening assembly.

### CROSS REFERENCE TO RELATED APPLICATIONS

This patent application is a divisional of U.S. patent application Ser. No. 10/149,006 filed Jun. 12, 2000.

### BACKGROUND

Field of the Invention

This invention relates to a screening module. More particularly, the invention relates to a screening module and to a screening assembly including such module.

### SUMMARY

According to the invention, there is provided a screening assembly framework which includes:

a plurality of support members, each of which supports at least one securing element by which a screening module is secured to the support member; and

a plurality of spacer members arranged intermediate the support members for retaining the support members at a predetermined distance relative to one another, at least certain of the support members and at least certain of the spacer members being demountably connected to one another to form a demountable underlying structure for an array of screening modules of the screening assembly.

At least certain of the support members may carry at least one receiving formation for receiving a complementarily-shaped end of one of the spacer members. Each receiving formation may comprise a boss extending from a side of the support member, the boss defining a slot in which said end of the spacer member is received, the slot and the end having complementary retaining formation for retaining the end of the spacer member in the slot.

Each securing element may comprise a receiving rail running along a top surface of the support member.

At least certain of the support members may carry mounting formations for removable mounting to a screen deck on which the screening assembly is to be installed.

Each support member and each spacer member may be of a synthetic plastics material to facilitate releasable engagement, for example clipping engagement, between the support members and the spacer members.

The framework may be modular and may comprise a plurality of sub-frames, each sub-frame including at least one support member and at least one spacer member extending transversely to its associated at least one support member.

### DRAWINGS

An embodiment of the invention is now described by way of example with reference to the accompanying diagrammatic drawings in which:

FIG. 1 shows a plan view of a screening module;

FIG. 2 shows an end view of the module;

FIG. 3 shows a side view of the module;

FIG. 4 shows a three dimensional, exploded view of a screening assembly framework, also in accordance with the invention;

FIG. 5 shows a plan view of a component of the framework;

FIG. 6 shows a side view of the component of FIG. 5;

FIG. 7 shows an end view of the component of FIG. 5;

FIG. 8 shows a plan view of another component of the framework;

FIG. 9 shows a side view of the component of FIG. 8; and

FIG. 10 shows an end view of the component of FIG. 8.

### DETAILED DESCRIPTION

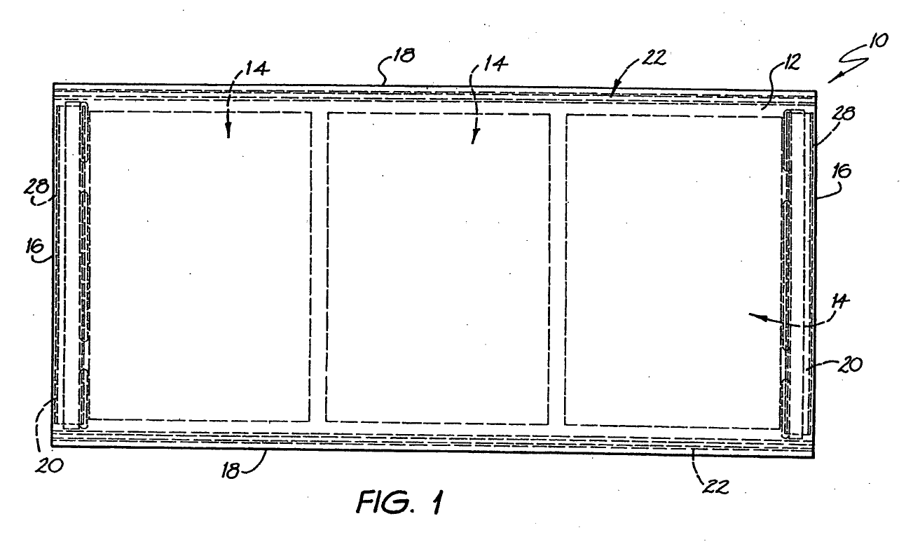

Referring firstly to FIG. 1 to 3 of the drawings, a screening module, is illustrated and is designated generally by the reference numeral 10. The screening module 10 comprises a substantially rectangular, planar screening member or deck 12 which defines a plurality of screening apertures therethrough illustrated schematically by panels 14 in FIG. 1 of the drawings. The module 10 has a pair of transversely spaced, longitudinal sides 16 and a pair of longitudinally spaced, transverse sides 18. The longitudinal sides 16, in use, extend parallel to a direction of flow of material over the module 10.

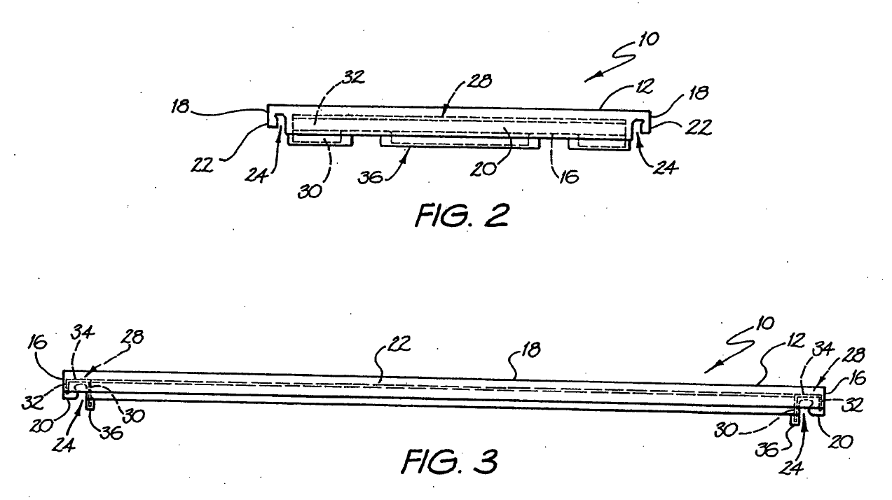

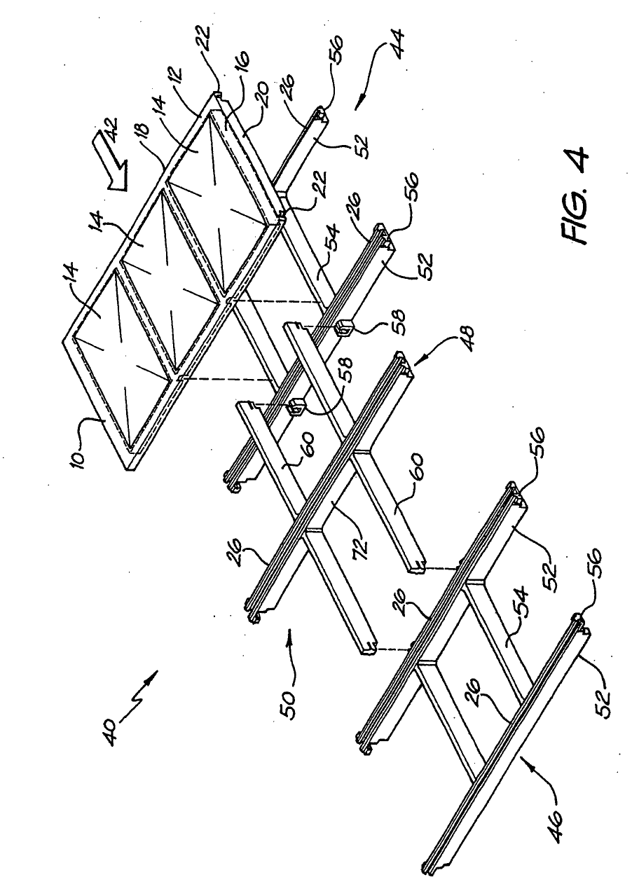

A mounting means in the form of a clip-like formation or clip 20 is arranged along each longitudinal side 16. Similarly, a mounting means in the form of a clip 22 is arranged along each transverse side 18. The clips 20 and 22 are shown in greater detail in FIGS. 2 and 3 of the drawings. It is to be noted that each clip 20, 22 defines a slot 24 therein which clips over a rail 26 (FIG. 4) as will be described in greater detail below.

The module 10 is formed integrally as a one-piece unit and is a moulding of a synthetic plastics material. More particularly, a flexible polyurethane material is used for the module 10.

To ensure that there is not too great a degree of flexing, in use, which would result in the module 10 being torn loose from its underlying structure, at least a part of the module 10 is reinforced.

In this regard, the sides 16 of the module 10 contain reinforcing 28 with the sides 18 being without reinforcing.

The reinforcing in the sides 16 extends into the clips 20 associated with the sides 16. As illustrated in FIG. 3 of the drawings, the reinforcing 28 straddles the slots 24 of the clips 20.

Thus, the reinforcing 28 comprises a plate 30 arranged inwardly of the slot 24 with a further plate 32 arranged outwardly of the slot 24. The plates 30 and 32 are interconnected by a bridging portion 34 arranged in the deck 12.

In addition, also to control flexing of the module 10, a locating means in the form of a shoulder 36 is arranged along each side 16 inwardly of the clip 24. Each shoulder 36 abuts against a side rail (not shown) extending in a direction parallel to the direction of flow of material and controls flexing of the module 10. It is to be noted that, to improve the rigidity of the shoulder 36, the reinforcing plate 30 of the reinforcing 28 extends into the shoulder 36.

Referring now to FIG. 4 of the drawings, a screening assembly, which includes a framework in accordance with an embodiment of the invention, is illustrated and is designated generally by the reference numeral 40. The screening assembly 40 includes a plurality of screening modules 10, only one of which is shown. The screening modules 10 are arranged in side-by-side and end-to-end relationship to form a screening surface over which material passes to be screened. The material moves in the direction of arrow 42.

The framework of the screening assembly 40 is modular and includes a feed end frame 44, a discharge end frame 46 and an intermediate, connecting, frame 48. These frames 44, 46 and 48 clip into standard rails (not shown) to form an underlying structure 50 for the modules 10.

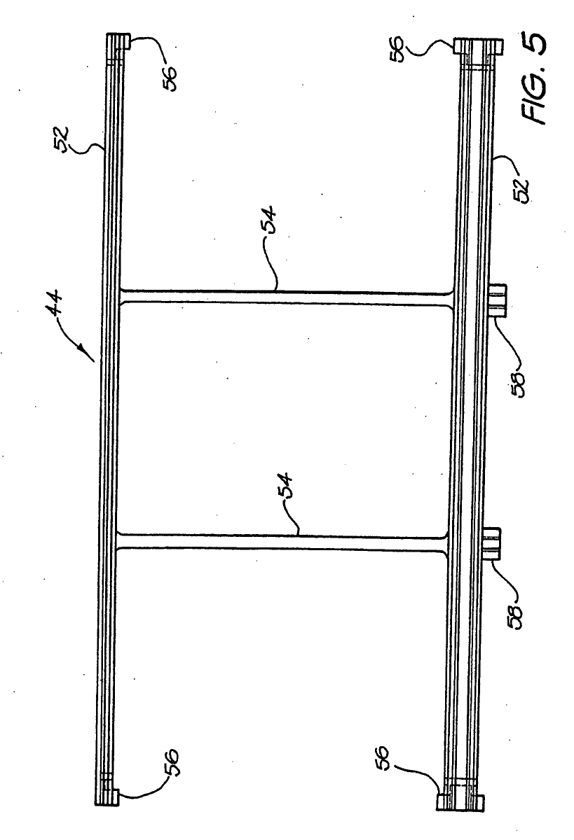

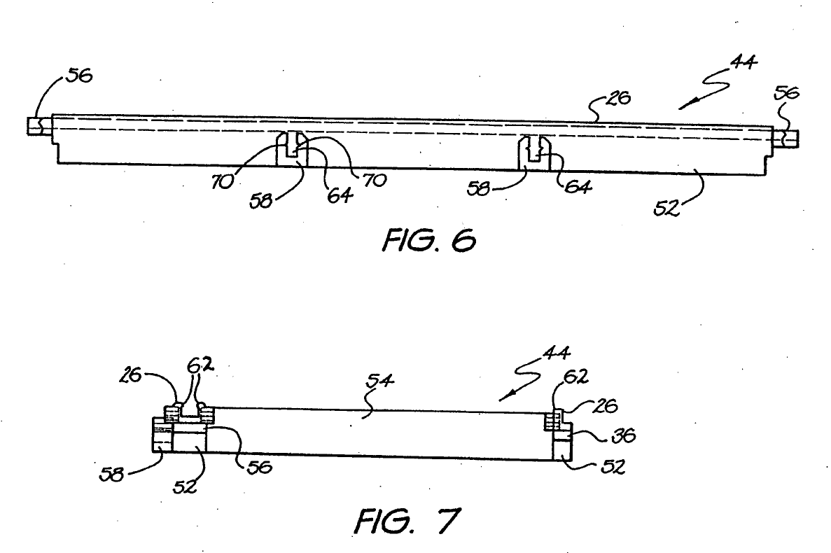

The feed end frame 44 and the discharge end frame 46 are of substantially the same construction and, accordingly, only one of the frames, the feed end frame 44, is discussed in greater detail. As illustrated in FIG. 5 of the drawings, the feed end frame 44 comprises a ladder-like structure having a pair of side rails 52 interconnected by cross members 54. Ends of the rails 52 have engaging formations 56 for engaging and being secured to the underlying standard rails.

On one side of one of the side rails 52, opposite its junction with the cross-members 54, receiving formations 58 are defined for receiving connecting, or spacer, members 60 of the intermediate frame 48.

The receiving rail 26 runs along the top of each rail 52. Each receiving rail 26 includes clips 62 which are received in the slots 24 of the clips 20, 22 of the modules 10. The modules 10 are clipped on to the rails 26 by means of a dedicated “roll-on” tool to attach the modules 10 to the underlying structure 50 securely.

Referring again to the receiving formations 58, it is to be noted that each receiving formation 58 defines a slot 64 in which an end 66 of one of the connecting members 60 of the intermediate frame 48 is received. The end 66 of the connecting members 60 has ribs 68 which engage recesses 70 in the slots for connecting the intermediate frame 48 to the feed end frame 44 and the discharge end frame 46.

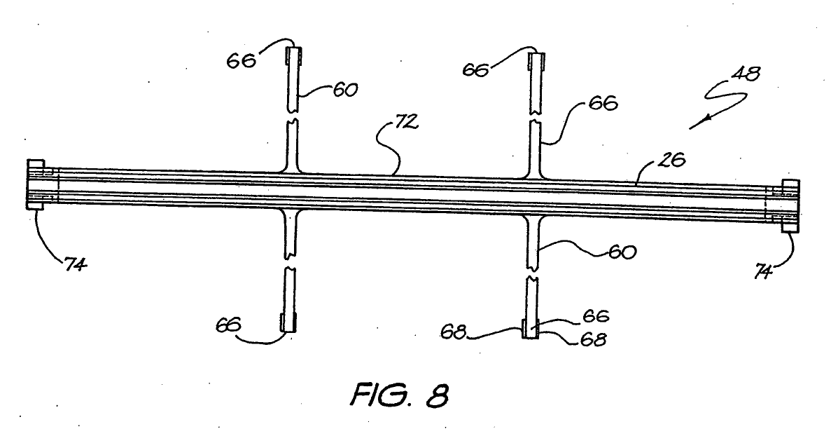

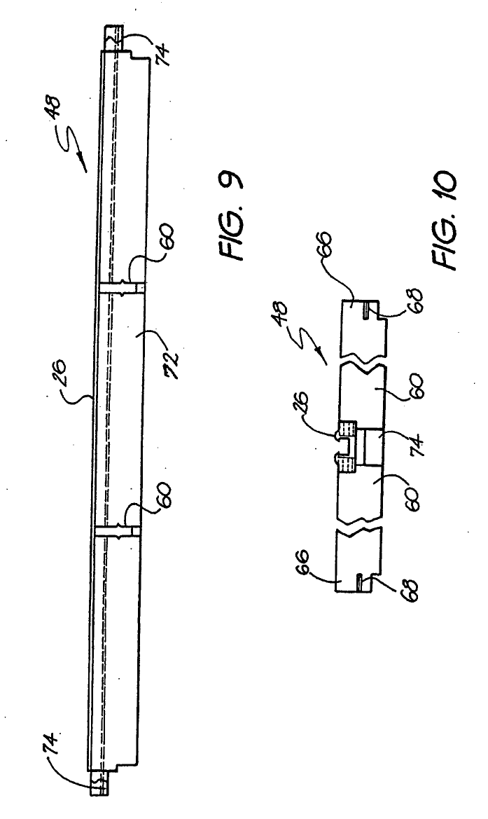

The intermediate frame 48 has a central spine 72 (FIGS. 8 to 10) from which the connecting members 60 project at right angles. A connecting formation 74 is arranged at each end of the spine 72 for connecting the intermediate frame 48 to the underlying rails.

As in the case of the feed end frame 44 and the discharge end frame 46, a connecting rail 26 is arranged on top of the spine 72 for securing the modules 10 to the intermediate frame 48.

It is a particular advantage of the invention that a screening module 10 is provided which can readily be “peeled” off the underlying structure 50 to be replaced without the need to disassemble the underlying structure 50. Also, due to the demountability of the underlying structure 50, should a component of the structure 50 be damaged, it can be readily replaced without replacing the whole underlying structure.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

We claim:

1. A screening assembly framework which includes:
a plurality of support members, each of which supports at least one securing element by which a screening module is secured to the support member; and
a plurality of spacer members arranged intermediate the support members for retaining the support members at a predetermined distance relative to one another, at least certain of the support members and at least certain of the spacer members being demountably connected to one another to form a demountable underlying structure for an array of screening modules of the screening assembly.

2. The framework of claim 1 in which at least certain of the support members carry at least one receiving formation for receiving a complementarily-shaped end of one of the spacer members.

3. The framework of claim 2 in which each receiving formation comprises a boss extending from a side of the support member, the boss defining a slot in which said end of the spacer member is received, the slot and the end having complementary retaining formation for retaining the end of the spacer member in the slot.

4. The framework of claim 1 in which each securing element comprises a receiving rail running along a top surface of the support member.

5. The framework of claim 1 in which at least certain of the support members carry mounting formations for removable mounting to a screen deck on which the screening assembly is to be installed.

6. The framework of claim 1 in which each support member and each spacer member is of a synthetic plastics material to facilitate releasable engagement between the support members and the spacer members.

7. The framework of claim 1 which is modular and comprises a plurality of sub-frames, each sub-frame including at least one support member and at least one spacer member extending transversely to its associated at least one support member.
